(19) United States
(12) Patent Application Publication
(10) Pub. No.: US 2011/0023291 A1
(43) Pub. Date: Feb. 3, 2011

(54) MODULAR PROTOTYPING OF A CIRCUIT FOR MANUFACTURING

(76) Inventor: James Peter Caska, Etten-Leur (NL)

Correspondence Address: FROMMER LAWRENCE & HAUG, 745 FIFTH AVENUE- 10TH FL., NEW YORK, NY, 10151, US

(21) Appl. No.: 12/848,089

(22) Filed: Jul. 30, 2010

Related U.S. Application Data
(60) Provisional application No. 61/230,563, filed on Jul. 31, 2009.

(51) Int. Cl. B23P 19/00

(52) U.S. Cl. 29/739

(57) ABSTRACT

An integrated method of prototyping and manufacturing electronic circuit boards where a new circuit design can move between virtual, prototype, partially merged and fully merged forms in a relatively automated fashion. A scaleable high density matrix of solderless electrical connections between the pin-outs of a plurality of electronic modules forms a virtual breadboard prototype circuit that can be merged into printed circuit board electrical layers to thus directly synthesize manufacturable forms of prototyped electronic circuits.

### CROSS REFERENCE TO RELATED APPLICATION

This application claims the benefit of U.S. Provisional Application, titled “MODULAR MANUFACTURABLE BREADBOARD SYSTEM, ” Ser. No. 61/230,563 filed on Jul. 31, 2009, the benefit of which is hereby claimed under 35 U.S.C. §119(e), and which is further incorporated herein by reference.

### FIELD OF THE INVENTION

The invention is directed to the design of electronic circuit boards, and more specifically to enabling the arrangement and testing of a variety of different electronic circuits prior to their manufacture on a printed circuit board.

### BACKGROUND OF THE INVENTION

Printed circuit boards are commonly used to provide electronic circuits for a wide variety of applications. In the manufacturing process, conductive traces are deposited on the substrate of the circuit board and discrete electronic components are assembled thereon. In large quantities the cost of manufacturing an electronic circuit board can be relatively inexpensive because many of the relatively high set up costs can be amortized over the relatively large quantity of electronic circuit boards. However, the cost for manufacturing a single or small quantity of electronic circuit boards can be very high due to the lack of amortization of the relatively high set up costs.

During the initial design of an electronic circuit, one off prototypes are created with any of a multitude of techniques, such as a breadboard, wire-wrap, veroboard, rats nest, and the like. In the past, the conductive traces/pins of most electronic components were exposed underneath the component's packaging, such as a dual inline packaging (DIP), which made it practical to prototype an electronic circuit without having to manufacture an electronic circuit board. More recently, the traditional DIP packaging of many electronic components has changed to incorporate surface mount pins that often require at least a special adapter to reroute the pins underneath the component, so that the surface mount component can be tested/used in a prototype.

Prototypes are useful for designing new electronic circuits which can be tested and evaluated before incurring the initial setup costs and time-delay associated with manufacturing an electronic circuit board and assembling the requisite electronic component on the board. Also, a prototype is often simpler to troubleshoot for design flaws, and it can provide a platform for other development tasks, such as developing software early on in the development lifecycle.

For all their benefits, prototypes can be time consuming to build and prone to errors during construction due to the nature of the wiring and can require considerable skill and mechanical and electrical aptitude to construct. Another issue is that a prototype circuit is typically not robust enough to be deployed in the field application and the poor relationship of the dimensions with the final form. Thus, manufacture of an electronic circuit board and assembly of the electronic components is usually done before field application testing of the new design of the electronic circuit occurs.

Also, once a prototype is vetted as ready for field testing the new design must be converted into electronic schematic data suitable for enabling the manufacture of the newly designed electronic circuit and board. Although many conversion procedures are known, there can be problems in part because steps are often discrete from each other and the transfer of various types is often required between steps. The new design is also converted to a bill-of-materials to be sourced by electronic component vendors. The design also needs to be transferred to automated manufacture and assembly instructions, such as for pick and place machines and so on. Each of these transfers requires highly specialized skills and consumes considerable time and cost.

### BRIEF DESCRIPTION OF THE DRAWINGS

FIG. 1 shows a general representation of an electric schematic diagram and decomposition of schematic into sub-circuits that can be wired together to form new circuits.

FIG. 2 illustrates a diagram of connection density of prior art breadboard compared an embodiment of the invention.

FIG. 3 shows a high density solderless connection methodology.

FIG. 4 illustrates the assembly for an electronic circuit in prototype form.

FIG. 5 shows an assembled prototype.

FIG. 6 illustrates an assembly of an electronic circuit from a bottom view showing a pin connection matrix.

FIG. 7 shows an assembled prototype from a bottom view.

FIG. 8 illustrates an assembled prototype with two routing layers for extra connections.

FIG. 9 shows an assembled circuit in partially merged form with the routing layers merged into a single multiple layer application specific printed circuit board.

FIG. 10 illustrates an embodiment of an assembled circuit in fully merged form with all layers merged into a single multiple layer application specific printed circuit board.

FIG. 11 shows a parametric representation of embodiments of the host board.

FIG. 12 illustrates an embodiment found by fixing the parameters.

FIG. 13 shows an embodiment of an cutaway Printed Circuit Board (PCB) layer construction and pattern template.

FIG. 14 illustrates an embodiment of an Extended Printed Circuit Board (EPCB) pattern template for a plurality of columns.

FIG. 15 shows an embodiment of an electrical path if contact pins are inserted into a matrix.

FIG. 16 illustrates an embodiment of a cutaway Printed Circuit Board (PCB) construction for two routing layers.

FIG. 17 shows an embodiment of a cutaway Printed Circuit Board (PCB) construction for a partially merged form with two routing layers.

FIG. 18 illustrates an embodiment of a Printed Circuit Board pattern template for a partially merged form.

FIG. 19 shows an embodiment for a cutaway Printed Circuit Board (PCB) construction for a partially merged form with three routing layers and modules with four layers.

FIG. 20 illustrates an embodiment of a cutaway Printed Circuit Board (PCB) construction for a relatively standard fully merged form with one routing layer and modules with two layers.

FIG. 21 shows an embodiment of a cutaway Printed Circuit Board (PCB) construction for a fully merged form with three routing layers and modules with four layers.

FIG. 22 illustrates an embodiment of a Printed Circuit Board (PCB) pattern template for shared bus rails.

FIG. 23 shows an embodiment of a sample module assembly document generated by a Virtual Breadboard Computer Aided Design tool.

FIG. 24 illustrates an embodiment of a sample contact pin assembly document generated by a Virtual Breadboard Computer Aided Design tool

FIG. 25 shows an embodiment of a generic hierarchical form of an arrangement of host boards.

FIG. 26 illustrates an embodiment of a Printed Circuit Board (PCB) pattern template for realizing hierarchical configurations.

### DESCRIPTION OF THE EMBODIMENTS

Various embodiments of the present invention will be described in detail with reference to the drawings, where like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

Throughout the specification and claims, the following terms take at least the meanings explicitly associated herein, unless the context dictates otherwise. The meanings identified below do not necessarily limit the terms, but merely provide illustrative examples for the terms. The meaning of “a,” “an,” and “the” includes plural reference, and the meaning of “in” includes “in” and “on.” The phrase “in one embodiment,” as used herein does not necessarily refer to the same embodiment, although it may. Similarly, the phrase “in some embodiments,” as used herein, when used multiple times, does not necessarily refer to the same embodiments, although it may. As used herein, the term “or” is an inclusive “or” operator, and is equivalent to the term “and/or,” unless the context clearly dictates otherwise. The term “based, in part, on”, “based, at least in part, on”, or “based on” is not exclusive and allows for being based on additional factors not described, unless the context clearly dictates otherwise. The term “coupled” means at least either a direct electrical connection between the items connected, or an indirect connection through one or more passive or active intermediary devices. The term “signal” means at least one current, voltage, charge, temperature, data, or other signal.

Throughout the Application some terms having a particular meaning are used, including and not limited to the following. The term Virtual Breadboard or VBB is directed to a computer aided design tool (CAD) for designing, simulating and synthesizing electronic circuits based on the present invention. The term FLEXTILES is directed to electronic modules designed according to design constraints. The term FLEXFLOOR is directed to electronic host boards from FLEXTILES that are designed according to parameters. The term FLEX PINS is directed to routable pins in the left column of a FLEX Column.

Briefly stated, the invention is related to a method and apparatus for the prototyping and manufacturing of electronic circuit boards, which automate and substantially eliminate the transfers/conversions between design and manufacturing stages saving considerable time and cost, as well as reducing the range of skills required to achieve an electronic design and enabling prototypes to be deployable in a field application.

A mechanism is described for creating a scaleable high density array of solderless electrical connections between the pin-outs of a plurality of electronic modules in such a way that resulting mechanical layers can later be merged into printed circuit board electrical layers; thus, directly synthesizing manufacturable forms of the prototyped electronic circuits.

Electronic circuits come in any number of shapes and sizes and configurations. To be applicable to a large subset of all possible electronic circuits, one embodiment is described as a parametric template of the forms of circuit board that can be synthesized. Selecting parameters yields an application specific embodiment.

Embodiments can have a plurality of interchangeable forms, such as: a prototype form, a partially merged form, a fully-merged form, and a virtual form.

The prototype form can consist of: a plurality of modules referred to as FLEXTILES, a host circuit board referred to as a FLEXFLOOR, a plurality of contact pins and one or more routing circuit boards. Prototype circuits can be constructed by inserting FLEXTILES into a FLEXFLOOR in the locations required for the designated routing and inserting contact pins into the routing layer or layers before securing the layers together to form a complete and robust electrical circuit.

The partially merged form can consist of a plurality of FLEXTILE modules and an application specific FLEXFLOOR with embedded routing. Partially merged circuits can be constructed by inserting FLEXTILES into the locations required by the embedded routing to form a an electrical circuit.

The fully merged form can consist of a fully application specific circuit, whereby the FLEXTILE circuitry and routing has been transferred/converted to the printed electronic circuit in an automated fashion and manufactured and assembled in the industry standard process to form a complete and robust electronic circuit.

A virtual form of the embodiment of the present invention can exist in the Virtual Breadboard computer aided design (CAD) tool used to facilitate the design and synthesis of electronic circuits described by the present invention. In virtual form a 3D computer model representation of a FLEXFLOOR is selected from a library of available FLEXFLOORS and placed onto a design sheet. Virtual 3D representations of FLEXTILE modules can then be selected from a library of available FLEXTILES and laid out on the FLEXFLOOR on the design sheet in locations that are constrained to be valid by the software. Once the layout is complete, a functional schematic diagram of the modules can be generated as an abstract representation of the application circuit. The pinouts from the function block description of FLEXTILES modules can then be wired together to specify the desired electrical connections. Once laid out and wired up, the Virtual Breadboard supports functional simulation of the resulting circuit application, which can be used to rapidly prototype and experiment with design solutions. At this stage, the design may be synthesized into at least one physical form.

The prototype form can be synthesized by generating a construction document, including the Bill-of-materials listing the FLEXTILE and FLEXFLOOR part numbers used, an assembly document illustrating the location of the FLEXTILES with respect to the FLEXFLOOR, and a pin-out layout diagram to locate and assemble the contact pins to correctly form the electrical connection matrix.

The partially merged form can be synthesized by generating a construction document,

Bill-of-materials listing the FLEXTILE and FLEXFLOOR part numbers used, an assembly document illustrating the location of the FLEXTILES with respect to the application specific FLEXFLOOR, and printed circuit board manufacturing documents for constructing the application specific FLEXFLOOR board. In one embodiment, the manufacturing build documentation can be in the form of multiple layer RS274X Gerber file.

The fully merged form can be synthesized by generating a Bill-of-materials in the form of individual components as merged from all included FLEXTILES, manufacturing documents that can include multiple layer RS274 Gerber files, and additional documentation suitable for use with assembly equipment for the purpose of substantially automating the setup and manufacture of the merged form circuit board.

Moving a final form three dimensional (3D)virtual representation to an abstract function block representation is the opposite approach to current art circuit design Computer Aided Design (CAD) software tools, which begin with an abstract schematic design that is then transferred to a printed circuit board and then, in the more advanced CAD tools, can a 3D representation of the electronic circuit complete with electronic components be rendered as a final verification step. Virtual Breadboard can also support the traditional approach of starting with an abstract functional block and generating the concrete layout from the abstract form, however, starting with the concrete physical visualization of the circuit is more intuitive and offers a more natural way for constructing circuits based on functionality and physical dimensions especially for those less experienced with schematic capture and electronics in general.

Some advantages of the invention include: (1) a solderless prototype can be robust enough for direct deployment in the field; (2) a new design can directly transfer to manufacturable versions; (3) an engineer can access relatively final hardware at the beginning of the design process; (4) virtual prototype versions of the relatively final hardware can enable further development even before any physical hardware is purchased or assembled; (5) since the modules are already proven designs, hardware design errors and transfer errors and bill of material conversion errors are greatly reduced; (6) modules encapsulate design knowledge reducing the time and skills needed to create a relatively similar module; (7) modules can be relatively ‘cut-and-paste’ from reference schematics so that conversion errors, routing errors, testing is reduced; (8) a FLEXTILE can incorporate a breadboard or a veroboard so that new modules may be used with existing modules; (9) hierarchical, whole other FLEXBOARDS can be exposed as a single FLEXTILE; (10) solder connections are eliminated sot that the circuit board and associated electronic components may be reused; and (11) prototype circuits can more closely match final printed circuit boards and can be used in the field application directly.

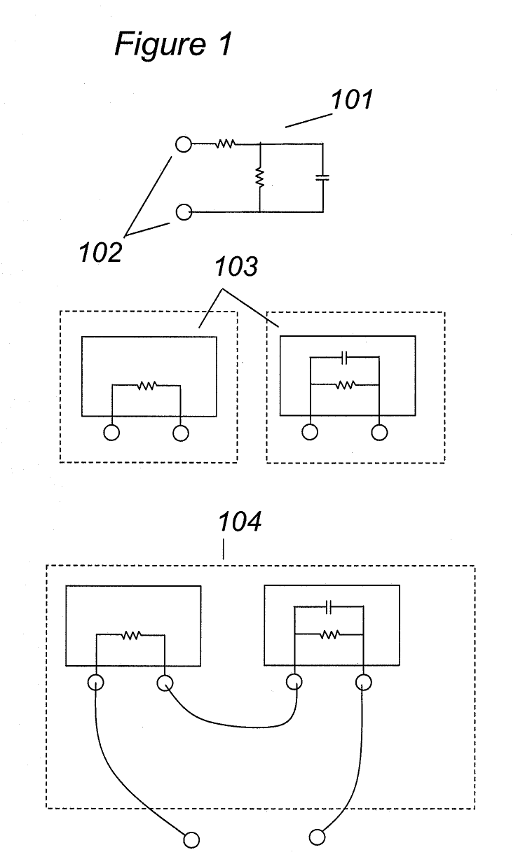

Referring to FIG. 1, Electronic circuits are represented as schematically with connected circuit components forming a circuit 101 with unresolved connections represented as terminal connections 102. Alternatively sub-circuit modules 103 can be wired together to form an electrically equivalent schematic 104. Modules are referred to as FLEXTILES consisting of a simple or complex sub-circuit, manufacturing data for automated synthesis and a virtual model for use with a design.

Electronic circuits are generally defined by wiring together the electrical pins of one or more FLEXTILES. At least one embodiment shows a method of arranging the modules and synthesis of these electrical connections between modules.

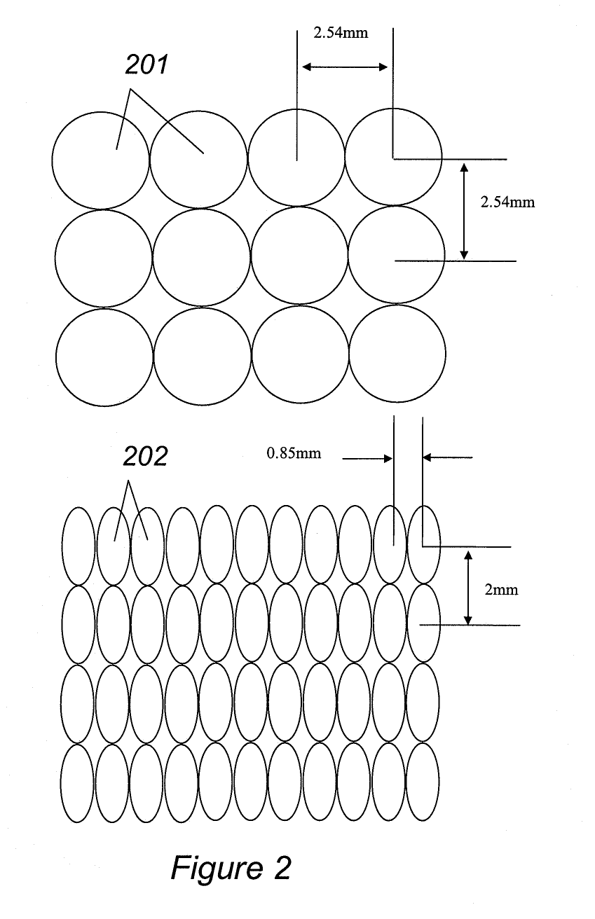

Referring to FIG. 2, solderless breadboard 201 uses a plug pin matrix of 2.54 mm×2.54 m (0.1 inch×0.1 inch). This density is also employed for veroboards, and other prototyping configurations. This density level may be limited to a point to point device as it limits the mechanical size and number of possible connections and assists in achieving density for manufacturing purposes. One embodiment employs mechanical arrangement 202 which yields a matrix of 2 mm×0.85 mm, an increase of 380% in one embodiment without the need of special manufacturing.

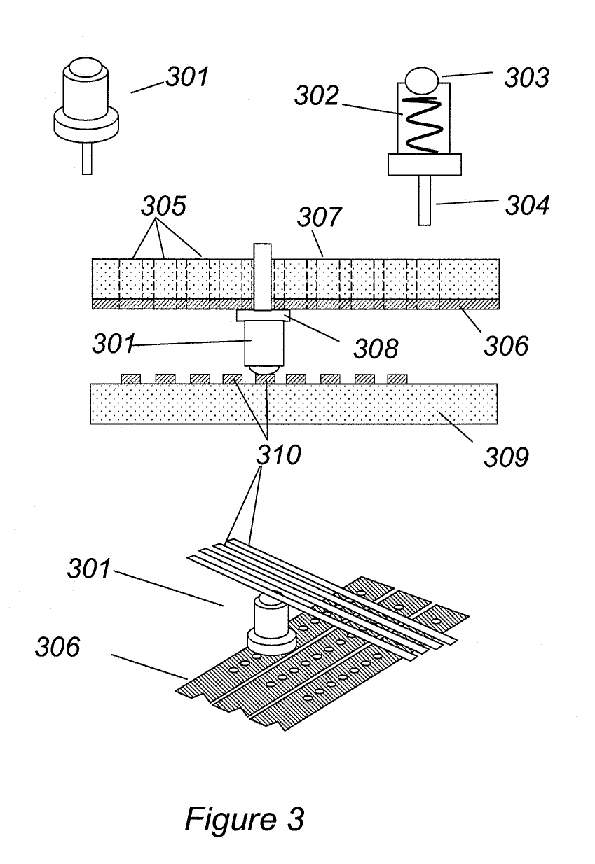

Referring to FIG. 3, commercially available spring loaded contact pin 301 consisting of an enclosed spring 302 contact head 303 and positioning shaft 304 can be inserted into positioning holes 305 drilled along the length of conductive strip 306, such as a copper strip, etched on single sided printed circuit board 307, the base of contact pin 308 makes contact with the top of conductive strip 306 of the upper printed circuit board 307 while the contact head makes a connection with the top conductive layer of second routing printed circuit board 309 which has perpendicular conductive strips 310 etched such that they align with the drill holes from the upper printed circuit board. By having drill holes along the length of a contact strip instead of a hole to hole contact, such as in veroboard or breadboard, high contact densities can be achieved.

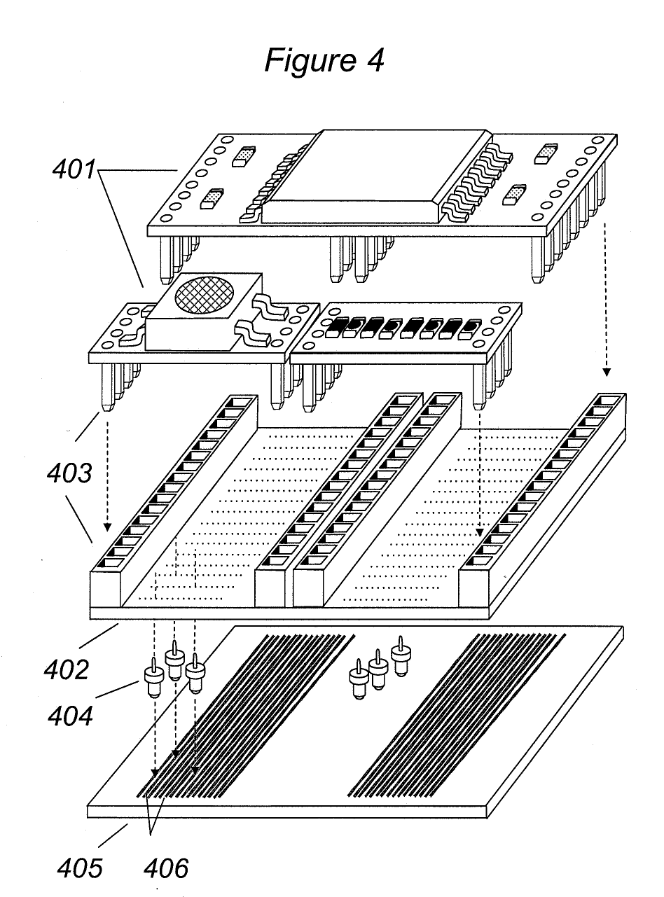

Referring the FIG. 4, an assembly diagram of a electronic circuit constructed by one embodiment is shown. FLEXTILE modules 401 designed with dimensions compatible with the corresponding FLEXFLOOR 402 can be assembled by inserting the modules into the printed circuit board header/receptacle pair 403. A plurity of contact pins 404 can be inserted into the positioning holes on the underside of the FLEXFLOOR 402 and routing board 405 can be secured by suitable means to align its topmost conductive contact strips 406 with the positioning holes of the FLEXFLOOR.

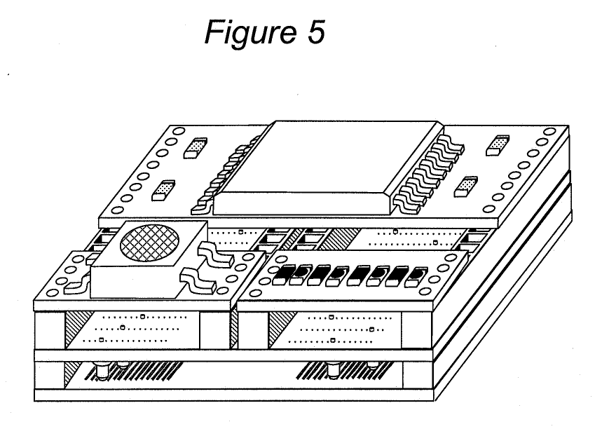

Referring to FIG. 5, an embodiment of the completed assembly representing a complete electrical prototype circuit is shown. Even in this prototype configuration the circuit board is robust and can have the same dimensions as the final circuit making it suitable for use in field applications.

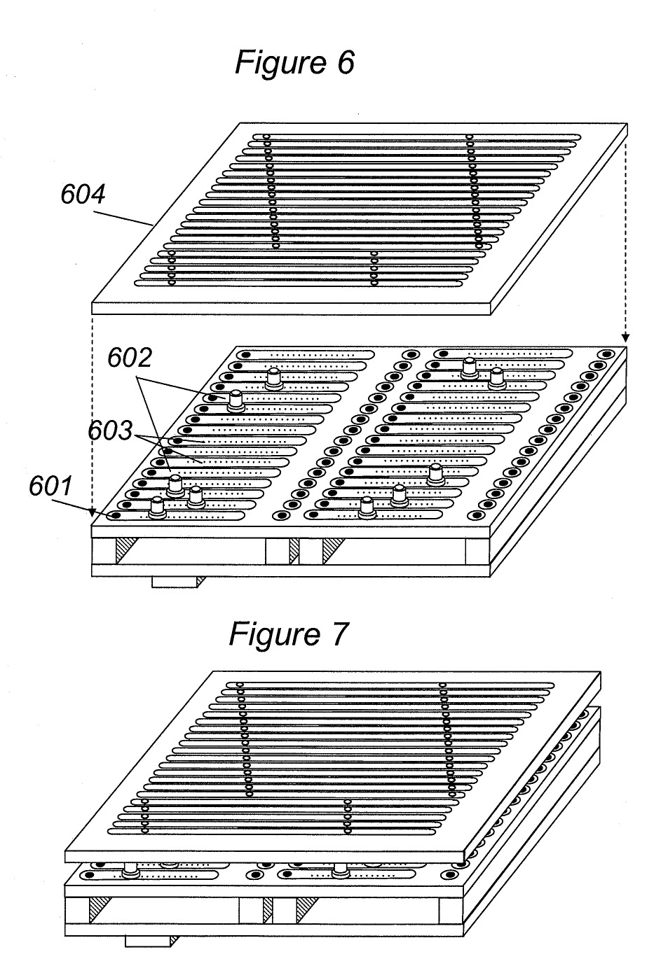

Referring to FIG. 6, an embodiment of the assembly procedure is shown from the underside perspective. From this perspective it can be seen that the receptacles connect to the horizontal strips on the underside of the FLEXFLOOR printed circuit board 601 into which contact pins 602 are inserted into the positioning holes 603 and the routing printed circuit board 604 is then assembled to complete the connections.

Referring to FIG. 7, an embodiment of the assembled board is shown.

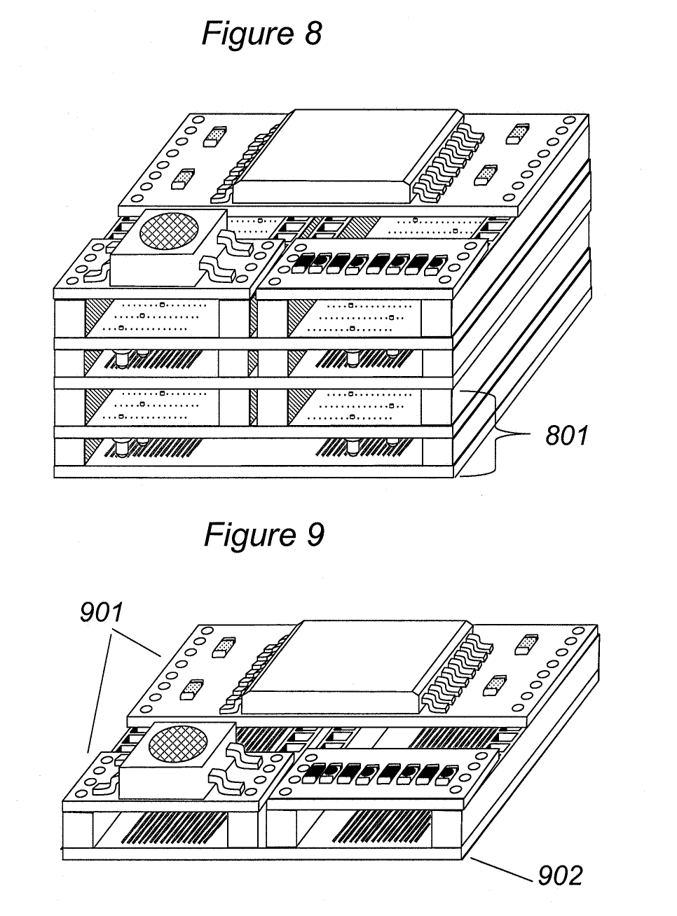

Referring to FIG. 8, one feature of the construction of at least one embodiment is that additional routing layers 801 may be added by repeating the previously described routing steps increasing the number of connections and hence the number of possible circuit configurations. Any number of additional routing layers can be added to achieve the desired number of connections.

Referring to FIG. 9, one embodiment of the partially merged circuit forms is shown where the routing layers have been embedded in a single applications specific FLEXFLOOR 902 into which the FLEXTILES 901 are assembled in substantially a similar way as for the prototype assembly.

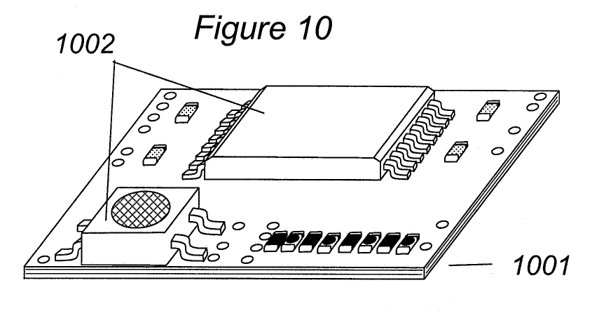

Referring to FIG. 10, one embodiment of the fully merged circuit form is shown where the printed circuit board layers of the FLEXTILES and the routing layers have all been merged into a single application specific circuit board 1001 with the electronic components from the FLEXFLOOR boards assembled thereon 1002.

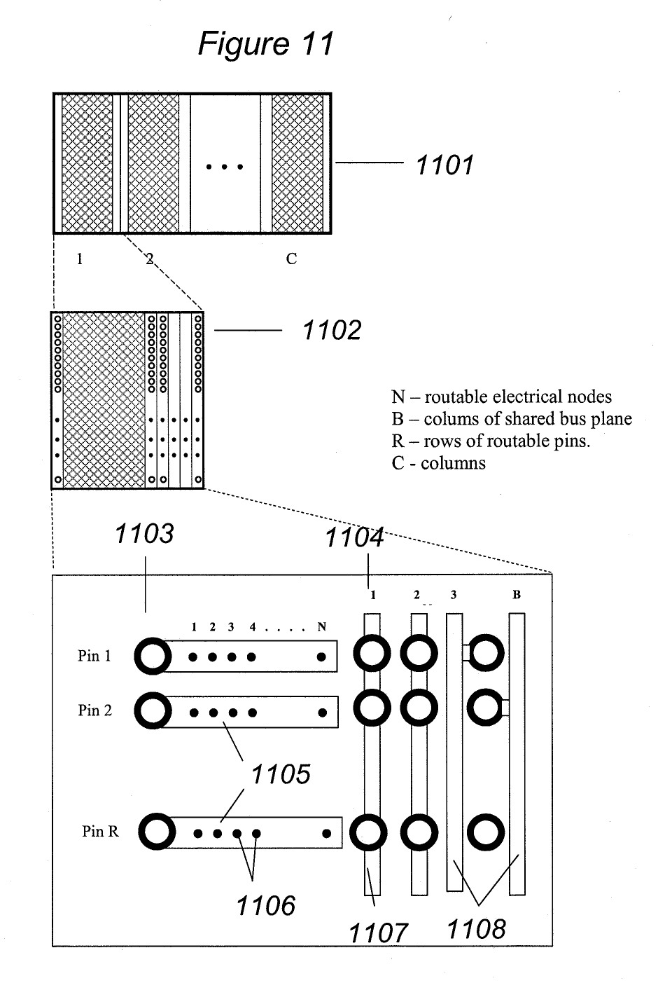

Referring to FIG. 11, one embodiment of the parametric description for describing FLEXBOARD embodiment of the present invention is defined. A FLEXBOARD comprises a plurality of horizontally aligned panels 1101 with C columns. Each panel 1102 comprises of a routable column on the left 1103 comprising of a plurality of R contacts which can make individual electrical contacts with any other routing column pin in any other panel. Each routable contact connects to a conductive contact strip 1105 which has N contact holes drilled 1106 where N is the number of unique possible connections per routing layer. Each panel also has B bus rails 1104. Bus rails can be straight through 1107 or interleaved 1108 or otherwise patterned so that they share electrical connections and are generally not individually routable. Selecting values for C,B,R,N depending on the nature of the application domain yield a specific FLEXBOARD embodiment.

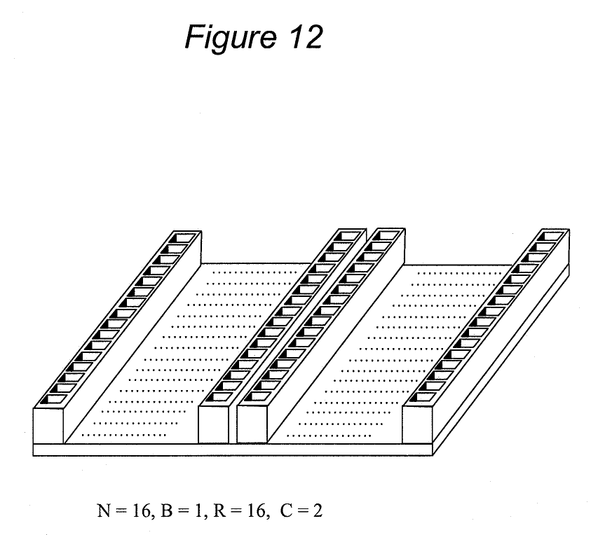

Referring to FIG. 12, one embodiment is shown of the FLEXBOARD with N=16 unique connections per routing layer, B=1 bus connection, R=16 contact rows and C=2 horizontal panels.

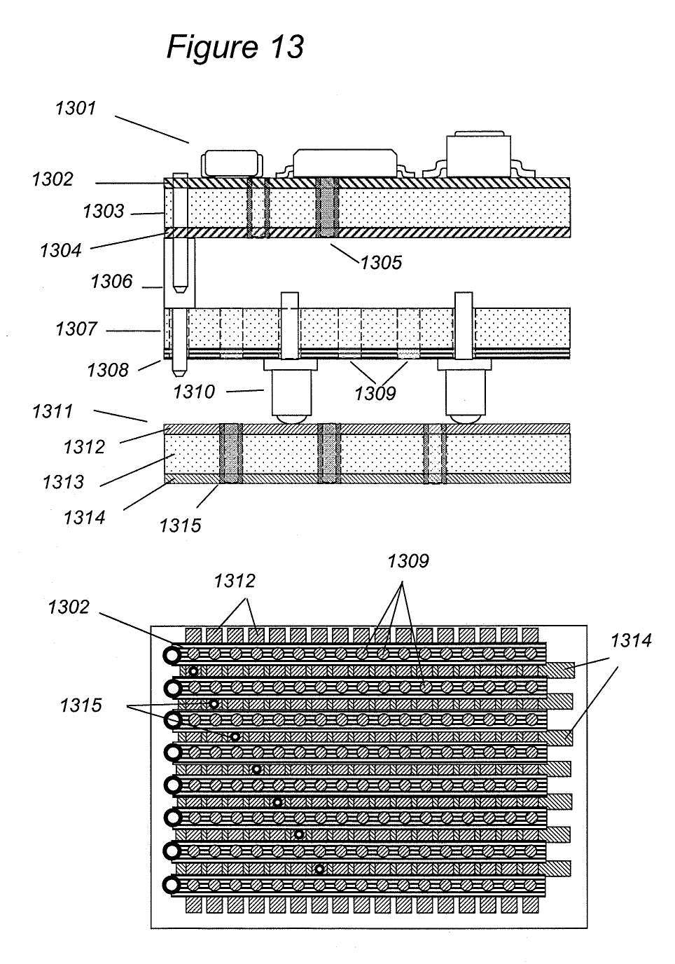

Referring to FIG. 13, one embodiment is shown for a two-dimensional cut through diagram and matching top down view of the printed circuit board layer patterns of an assembled prototype circuit. Electronic components 1301 can be surface mount assembled onto the top conductive layer FLEXTILE printed circuit board 1302. The FLEXTILE PCB is creating with standard techniques in this case a two layer printed circuit board with bottom conductive layer 1304 and through holes 1305 as part of the design. The FLEXTILE is edge connected using a standard type PCB header/connector 1306 to FLEXBOARD base board 1307 featuring one conductive side of solderless connection matrix 1308 and positioning pin drill holes 1309 which are used to position a collection of spring loaded contact pins 1310 representing the electronic netlist circuit completed by routing board 1311 with the vertical contact conductive material on top conductive layer 1312 and the bottom conductive layer etched with perpendicular conductive bridges separated by the PCB substrate 1313 with the link between the horizontal and vertical lines made with plated through-hole links 1315.

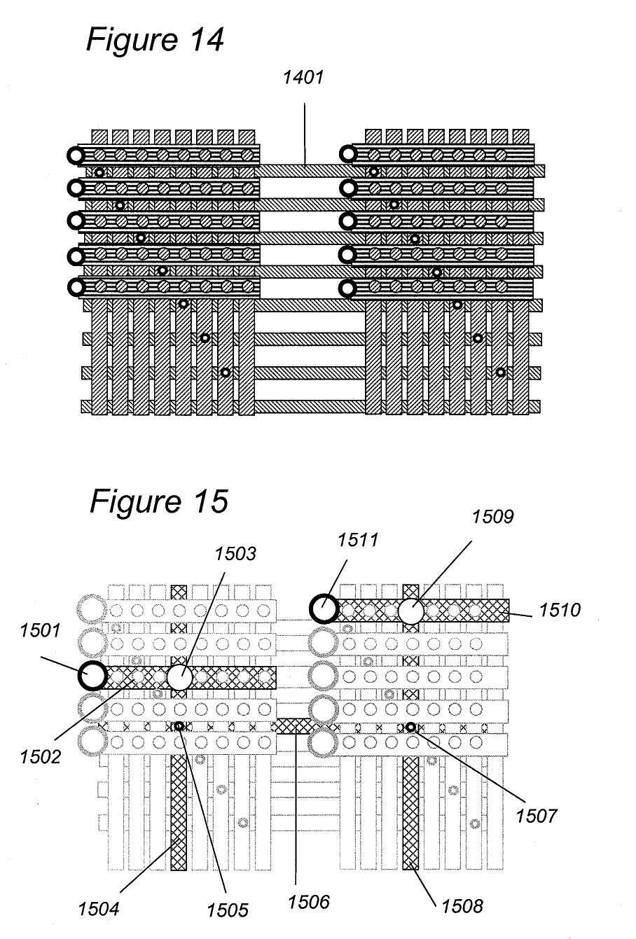

Referring to FIG. 14, an embodiment for the printed circuit board pattern from FIG. 13 is expanded to comprise an additional column linked by a horizontal connection bridge 1401 linking the panels together.

Referring to FIG. 15, an embodiment of the electrical path is shown connecting two arbitrary routable contacts. From the first pin 1501, horizontal FLEXFLOOR bottom layer strip 1502 is followed until the contact pin 1503 which connects to top routing board layer 1504 which is followed vertically until pcb via 1505 connects routing board bottom horizontal bridge conductive layer 1506 over which it travels until a second pcb via 1507 brings it to the top conductive layer vertical path 1508 which brings the path to a second contact pin 1509 which connects to the horizontal FLEXFLOOR bottom conductive layer strip 1510 that connects to the second pin.

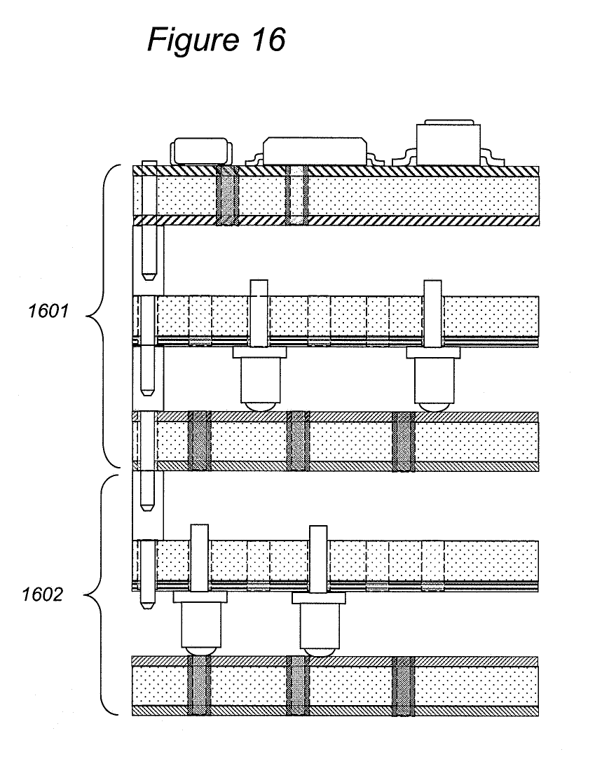

Referring to FIG. 16, an embodiment of the assembly from FIG. 13 (1601) is augmented with an additional routing layer 1602 doubling the number of available electrical connections.

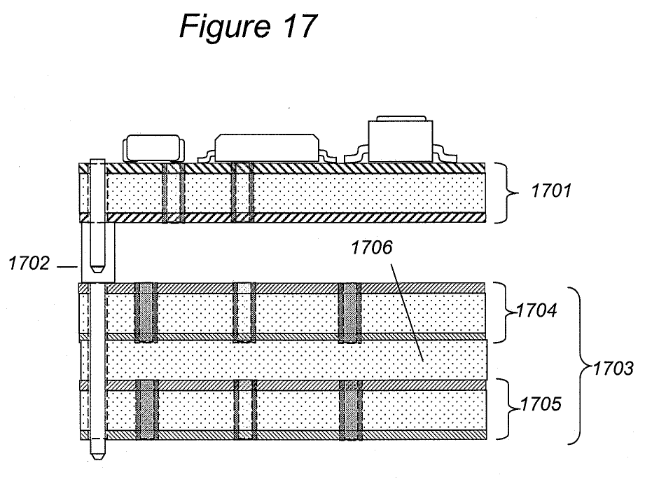

Referring to FIG. 17, an embodiment of the partially merged form is shown. The FLEXTILES 1701 and PCB connections 1702 are unchanged. The routing layers are merged into an application specific FLEXFLOOR 1703. This illustration features two routing layers merged into a four layer printed circuit board 1703 where the layers 1704 and 1705 are arranged on top of each other separated by the PCB substrate. A multilayer PCB construction technique may be used to create the application specific FLEXBOARDS.

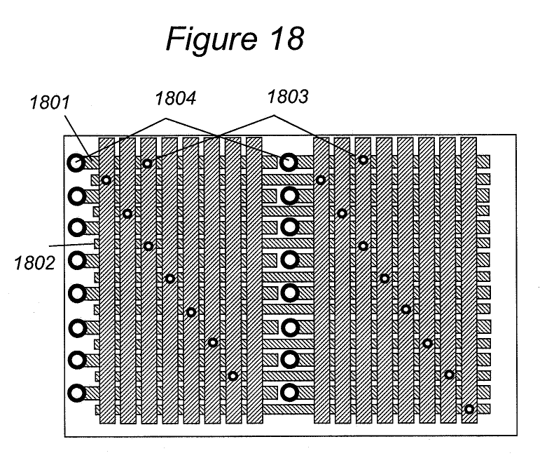

Referring to FIG. 18, an embodiment of the printed circuit board pattern for the merged form is shown. In prototype form three layers on two separate boards are used with the mechanical contact pin creating the circuit selection. In the merged form the two horizontal patterns are merged by reducing the thickness and removing the positioning drill holes of the FLEXFLOOR strip 1801, and putting it on the same layer as the horizontal strips from the routing layer 1802. PCB ‘via’ connections replace the mechanical pins 1803. For illustration an electrical circuit has been created between pins the two FLEX Pins 1804 by the positioning of the two routing vias 1803.

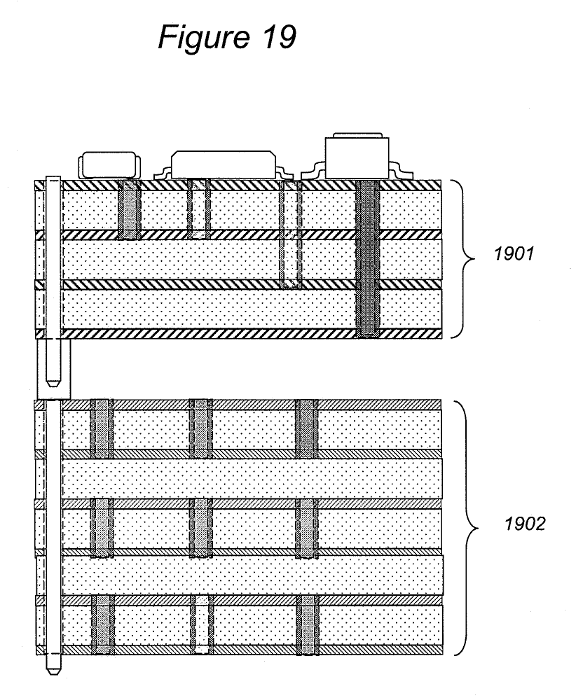

Referring to FIG. 19, shows an embodiment of a second example of an application specific FLEXBOARD PCB where the FLEXTILE module layer 1901 is a four layer module and the routing layer 1902 is a three layer routing layer. By comparing with FIG. 17 a general form of N layer modules and M routing layers is shown.

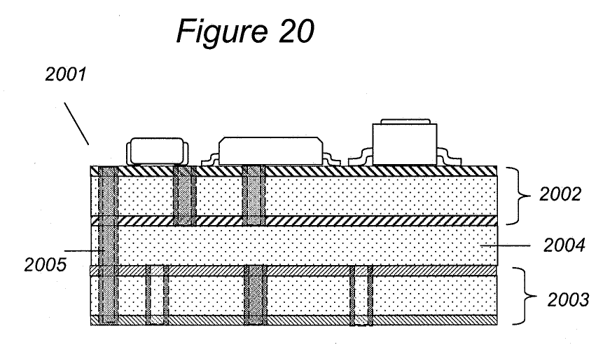

Referring to FIG. 20, an embodiment of the fully merged form is illustrated showing how a fully application specific circuit board 2001 is realized by merging the FLEXTILE 2002 and routing layers 2003 and replacing the pcb header/connector by a pcb substrate layer 2004 and through hole connection 2005 resulting in a single application specific electronic circuit that may be manufactured with multi layer pcb techniques. The routing layer pattern is unchanged from FIG. 18.

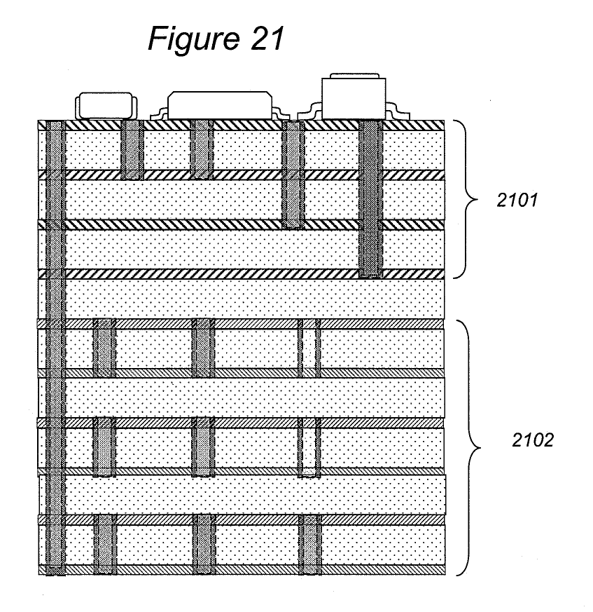

Referring to FIG. 21, an embodiment is shown for a second fully merged form with four layer modules 2101 and three routing layers 2102 can be used in a ten layer application specific printed circuit board. By comparing with FIG. 20, the general form of constructing a fully merged application specific printed board of the form N layer modules and M routing layers is shown.

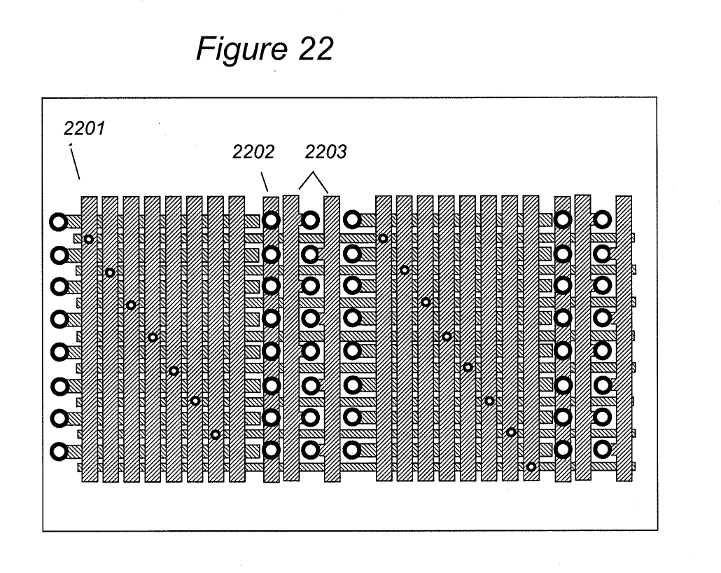

Referring to FIG. 22, an embodiment is illustrated for an example PCB that shows a layout template for the routing layer 2201 with a shared bus line of two forms straight through bus 2202 and interleaved bus 2203.

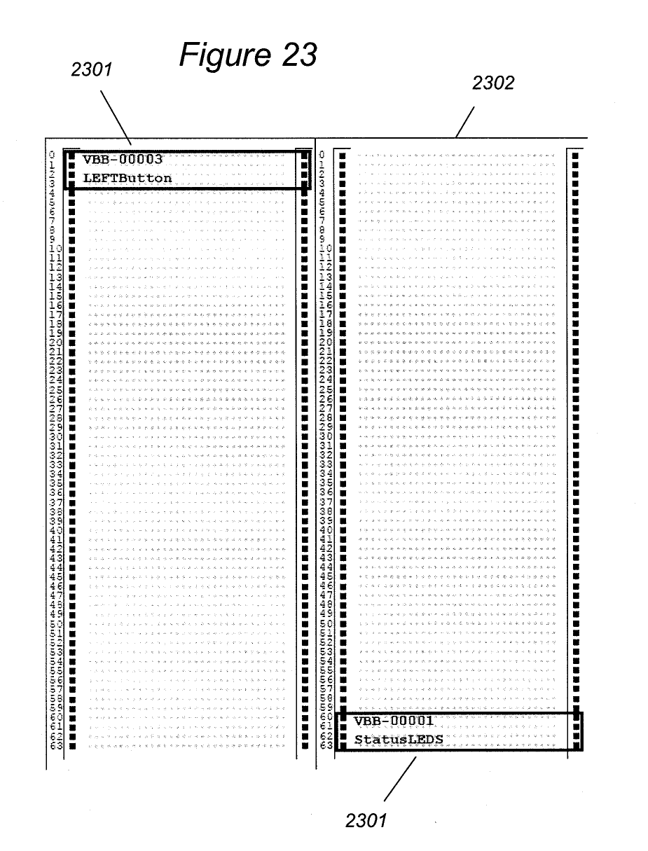

Referring to FIG. 23, one embodiment is shown of one example assembly document output from VirtualBreadboard illustrating the location of FLEXTILES 2301 with respect to FLEXFLOOR 2302.

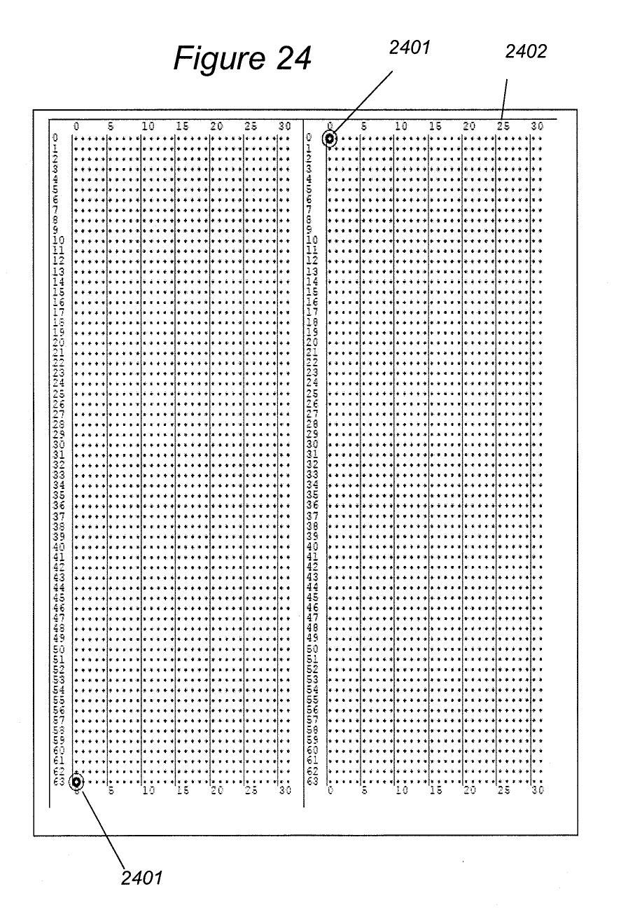

Referring to FIG. 24, one embodiment is shown of one example assembly document output from VirtualBreadboard illustrating the required location of contact pins 2401 with respect to a FLEXFLOOR 2402 positioning locations required to complete a specified electronic circuit.

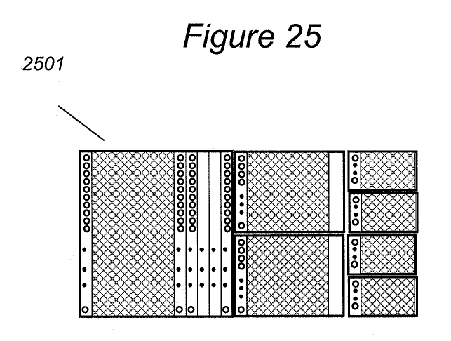

Referring to FIG. 25, one embodiment for a method of arranging FLEXFLOORS in a hierarchical arrangement is shown.

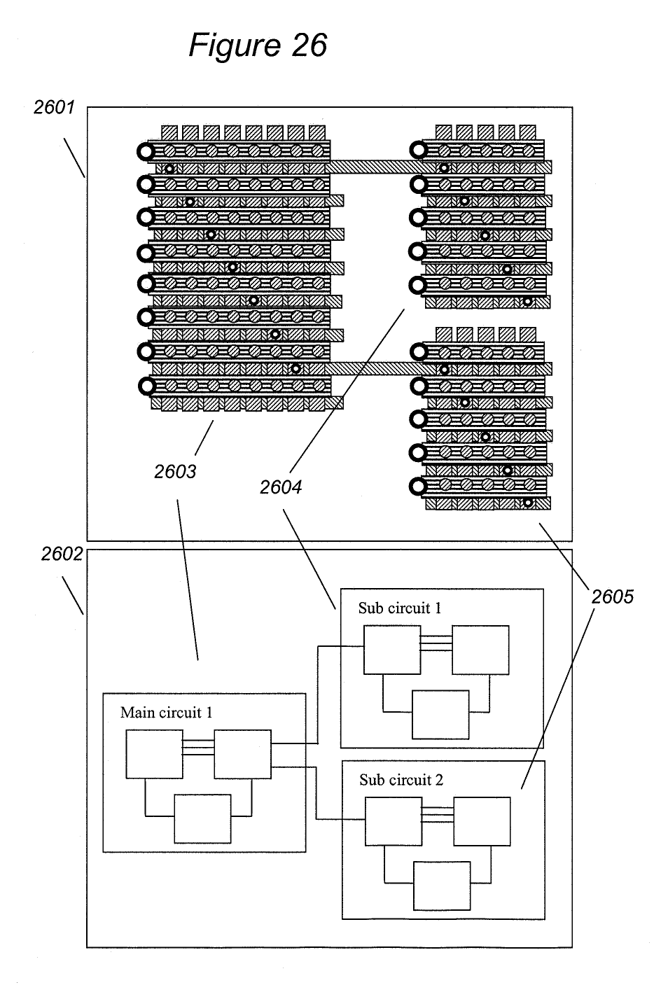

Referring to FIG. 26, one embodiment of the printed circuit board pattern of a hierarchical arrangement of FLEXFLOORS is shown 2601 along with a high level schematic diagram 2602 illustrating the type of circuit's arrangements facilitated by a hierarchical arrangement. Main circuit FLEXFLOOR 2603 is connected to two FLEXFLOOR sub-circuits 2604, 2605. One purpose of hierarchical arrangements such as this is to increase the density of possible electrical connections.

What is claimed as new and desired to be protected by Letters Patent of the United States is:

1. An apparatus for prototyping an electronic circuit, comprising:
a solderless electronic connection board;
an electronic circuit module that is arranged to couple to the connection board and electronically connect to at least one electronic component coupled to the connection board;
a first interface for testing the operation of the electronic circuit module connected to the at least one electronic component; and
a second interface for providing data to enable the manufacture of the arrangement of the electronic circuit module connected to the at least one electronic component on a printed circuit board.
